(19) United States
(12) Patent Application Publication
(10) Pub. No.: US 2009/0152096 A1
(43) Pub. Date: Jun. 18, 2009

(54) METHOD AND SYSTEM FOR THE APPLICATION OF MATERIALS TO IMPROVE INDOOR AIR QUALITY

(76) Inventor: John Carlson, Ivoryton, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/954,312

(22) Filed: Dec. 12, 2007

(51) Int. Cl. B01J 19/08; B01J 19/00; B05D 1/04

(52) U.S. Cl. 204/164; 422/120; 422/83; 427/475

(57) ABSTRACT

A system for treating a surface to prevent or limit offensive odors and/or microbiological activity and improve indoor air quality includes electrostatically charged particles of anatase titanium dioxide and a substrate or surface on which these particles are received. The electrostatic charging of the particles, in conjunction with the substrate being oppositely charged, provides a self-leveling effect to the particles. The particles may be incorporated into an HVAC system defined by ductwork in which untreated air including organic matter flows, is treated, and is ejected as clean air. Methods of treating surfaces or fluids containing organic matter include providing electrostatically charged particles of anatase titanium dioxide and contacting the organic matter therewith to initiate photocatalytic oxidation processes in which the organic matter is broken down into less offensive constituents such as carbon dioxide and water.

### TECHNICAL FIELD

The present invention relates generally to methods and systems for the application of materials to improve indoor air quality and, more particularly, to methods and systems that utilize photocatalytic oxidation to effect the treatment of offensive and undesirable odor-causing elements, inhibit microbial growths, and improve indoor air quality.

### BACKGROUND OF THE INVENTION

Various systems for the cleaning and/or deodorizing of surfaces are currently in use. Some systems are generally directed to controlling microbiological particles and other organic constituents via the physical removal of such particles by encapsulating and dispersing the particles which can then be flushed away with water or other solvents. In other systems, chemical agents are used to neutralize or provide some other chemical change to the offending particles. Most often, a system will utilize the combination of neutralization with chemical change and physical removal of the particles. Other systems, particularly those directed to controlling or abating offending odorous emissions, typically mask the particles with perfumes or the like. Still other systems utilize various types of filter media, for example, by promoting the collection of particles in or on material that traps and retains the particles or on surfaces that are ionically charged to attract oppositely charged particles.

### SUMMARY OF THE INVENTION

In one aspect, the present invention resides in a treatment system for improving indoor air quality and/or preventing or at least limiting offensive odors and/or microbiological activity such as mold growth or the proliferation of viruses, bacteria, and the like. This system includes particles of anatase titanium dioxide and a substrate or surface on which these particles are received. The titanium dioxide particles are electrostatically charged by being passed between two electrodes prior to deposition on the substrate, thereby charging the particles. The substrate or surface is grounded. Because the particles are similarly charged, they repel each other. However, because the particles are oppositely charged with respect to the substrate, they are attracted to the substrate. The repelling of the particles from each other and the attraction of the particles to the substrate allows the particles to be evenly distributed over the surface of the substrate, thereby exhibiting a self-leveling effect.

In another aspect, the present invention resides in an HVAC (heating, ventilation, and/or air conditioning) system for the photocatalytic treatment of airborne organic matter. The system is defined by ductwork in which untreated air is directed to flow. The untreated air includes organic matter (microbes, mold, viruses, bacteria, odorous particles, or the like). The ductwork is in communication with a reactor in which particles of titanium dioxide are introduced to provide for the catalytic oxidation of the organic matter, which is collected and removed from the air. The air is then ejected from the reactor as treated air. A light source may be employed with the ductwork to initiate the photocatalytic reaction.

In another aspect, the present invention resides in methods of treating surfaces and/or organic matter (e.g., volatile organic compounds (VOC)). In these methods, electrostatically charged particles of anatase titanium dioxide are provided. When the particles contact the organic matter, a photocatalytic oxidation process in which the organic matter is broken down into less offensive constituents is initiated. When a surface is treated, the constituents are neutralized by the titanium dioxide.

One advantage of the present invention is that the electrostatic charge imparted to the titanium dioxide particles causes the particles to repel each other. When deposited onto a grounded or negatively charged surface, the titanium dioxide particles provide a coating that is self-leveling. This coating is therefore more evenly applicable to a surface, which thereby results in a more complete and thorough treatment. Because of the ease with which this coating can be applied, the speed at which surfaces can be treated is vastly improved over methods of the related art.

### BRIEF DESCRIPTION OF THE DRAWINGS

FIG. 1 is a schematic representation of electrostatically charged particles of the present invention on a negatively charged surface.

FIG. 2 is a schematic representation of particles being electrically charged as they are ejected from a spraying device.

FIG. 3 is a schematic representation of particles being deposited onto a primer layer disposed on a substrate.

FIG. 4 is a schematic representation of a system of ductwork in which air is treated using the electrostatically charged particles of the present invention.

FIG. 5 is a schematic representation of electrostatically charged particles being deposited on a porous bed.

FIG. 6 is a schematic representation of electrostatically charged particles being sprayed into a chamber for contact with untreated air.

### DETAILED DESCRIPTION OF THE INVENTION

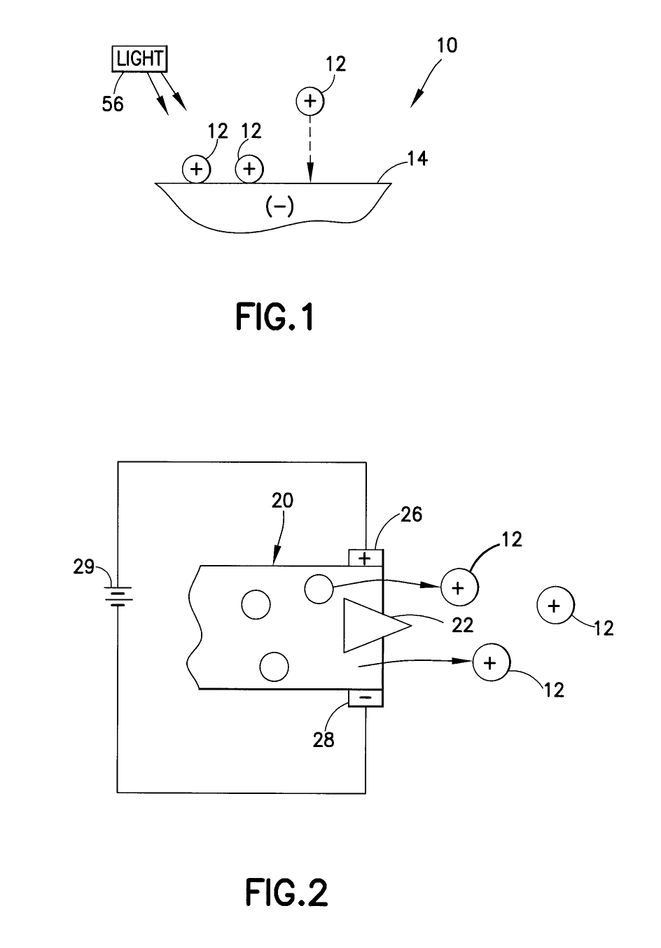

As is shown in FIG. 1, a system for treating surfaces using photocatalytic oxidation is designated generally by the reference numeral 10 and is hereinafter referred to as “system 10.” As used herein, the term “treating” means deodorizing and cleaning to produce an effect on indoor air quality. In system 10, particles 12 are electrostatically charged to have a positive charge such that these particles are attracted to a negatively charged or grounded substrate 14. The particles 12 are electrostatically charged as the result of being passed through an electrical field generated across electrodes. As the positively charged particles 12 approach the substrate 14, they are attracted to the surface of the substrate. Moreover, because the particles 12 are all positively charged (or at least mostly positively charged), the particles are attracted to the substrate 14 and repellant of each other, which provides a self-leveling effect and gives a substantially uniform coating of particles.

In one embodiment, the particles 12 are titanium dioxide particles of the anatase form. Anatase titanium dioxide is capable of oxidizing organic matter. When exposed to UV radiation (e.g., from sunlight or a light source 56), the electrons of the titanium dioxide are excited from their ambient energy levels to increased energy levels, which thereby allows for the generation of super oxide ions and hydroxyl radicals. The interactions of super oxide ions and hydroxyl radicals with organic matter facilitate the oxidation of the organic matter. Accordingly, when the particles 12 are coated onto the substrate 14 and come into contact with organic matter (e.g., microbiological particles, microorganisms, bacteria, viruses, mold, mildew, soot, deposits from cigarette and cigar smoke, and the like), the organic matter is oxidized and broken down into less offensive matter. Such less offensive matter may be, but is not limited to, carbon dioxide, water, and the like.

Although the substrate 14 is generally shown as a flat surface on which the particles 12 are capable of collecting, the present invention is not limited in this regard. For example, the substrate 14 may be a wall, floor, or ceiling on which organic matter has collected and for which treatment is desired. More specifically, the substrate 14 may be drywall (painted or unpainted), masonry, carpeting, tile, millwork, or any other building product. Also, the substrate 14 is not limited to building products, as the particles 12 can be applied to upholstery, tabletops, clothing, drapery, and plastic or polymeric materials such as light switches, keyboards and computer peripherals, touchpads, writing utensils and stationery products, shopping carts, and the like. In any application of particles 12 to a substrate 14, the particle material (e.g., the titanium dioxide) operates to oxidize organic matter.

In one embodiment of the present invention, as is shown in FIG. 2, the particles 12 are suspended in an aqueous medium and dispensed from a spraying device 20 onto the substrate 14. The spraying device 20 can be any suitable type of pressure-operated sprayer such as those typically used for spraying water. A nozzle 22 is located at an outlet of the spraying device 20 to control the flow of particles 12 from the spraying device. The nozzle 22 is capable of metering the spray from the spraying device 20 to provide a fine misting of particles to a surface to be treated.

When the particles 12 are suspended in the aqueous medium, the concentration of titanium dioxide in the medium is about 2 weight percent (wt. %), although higher or lower concentrations may be used without departing from the broader aspects of the present invention. Typically, the particles 12 are nanometer sized particles that are attached to water particles of about 14 microns in diameter. The attractive forces between the water particles and the titanium dioxide particles 12 are about 40 times the force of gravity.

Electrodes (a positive electrode 26 and a negative electrode 28) are located at the outlet of the spraying device 20. An electrical charge is passed across the electrodes via a battery 29. The present invention is not limited to the use of a battery for supplying the electrical charge, as other means of doing so (e.g., alternating current) are within the scope of the present invention.

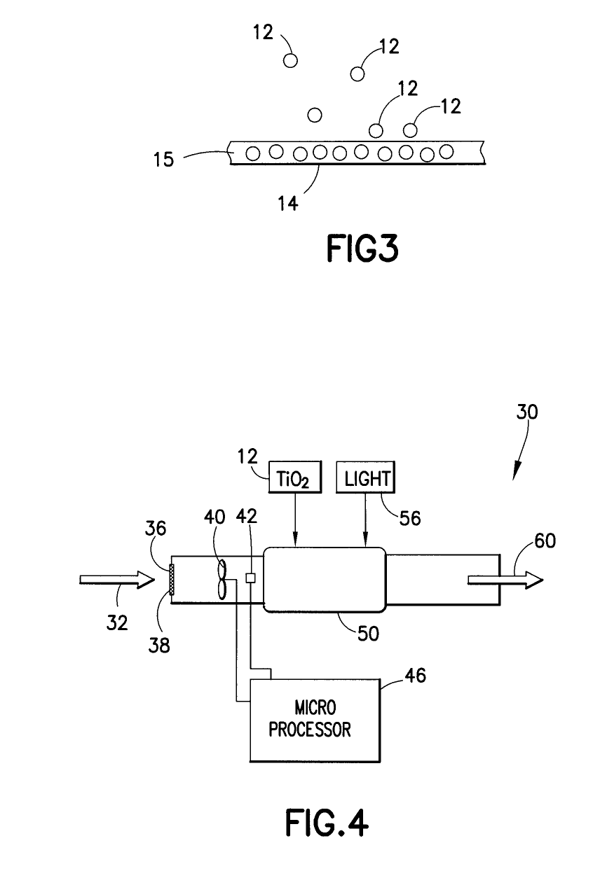

As is shown in FIG. 3, prior to the particles 12 being sprayed onto the substrate 14, a primer coat 15 can optionally be applied to the substrate 14 to facilitate the adherence of the particles. This primer coat 15 comprises encapsulated titanium dioxide particles and, more particularly, titanium dioxide particles that are suspended in a gel. The primer coat 15 is applied in the same or a similar manner as in embodiments in which the particles 12 are applied to the substrate 14 without the primer coat 15.

In another embodiment of the present invention, as is shown in FIG. 4, the particles 12 can be introduced into an HVAC (heating, ventilation, and/or air conditioning) system of a building. The present invention is not limited to buildings, however, as the particles can be introduced into similar systems such as those characteristic of motor vehicles (such as cars, airplanes, buses, trains, and the like) as well as other enclosed areas (such as subway tunnels and the like).

In a system of ductwork, which is designated generally by the reference numeral 30 and hereinafter referred to as “ductwork 30,” untreated air (shown at arrow 32) is drawn or forced through an inlet 36. The inlet 36 may include a filter 38 that separates and removes dust and other particulate matter as well as larger organic matter from the untreated air 32 as the air enters the ductwork 30. The present invention is not so limited, however, as the inlet 36 may include only a grate or the like that prevents larger debris from entering the ductwork 30.

The untreated air 32 is drawn into the ductwork 30 via a fan 40 or other apparatus capable of providing for the convective flow of air. An air flow speed detector 42 is located in the ductwork 30 to ascertain the speed of air flow through the ductwork. Both the fan 40 and the air flow speed detector 42 are in electrical communication with each other through a microprocessor 46 such that closed loop control of the air speed through the ductwork 30 is maintained.

As the air passes through the ductwork 30, the untreated air 32 is drawn into a reactor 50 and photocatalytically treated via electrostatically charged, photocatalytic titanium dioxide particles 12 and the light source 56. Electrical communication between the reactor 50 and the microprocessor 46 allows for closed loop control of treated air 60 as it exits the reactor. The treated air 60 is then ejected from the ductwork 30.

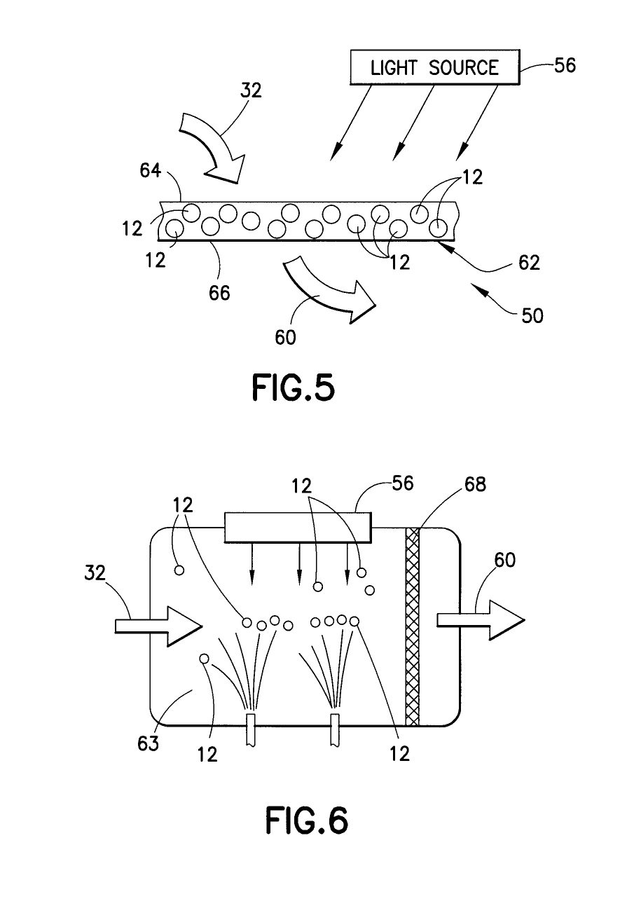

As is shown in FIG. 5, in one embodiment, the reactor 50 comprises the electrostatically charged titanium dioxide particles 12 impregnated into or otherwise disposed on a web or the like to provide a porous bed 62 having an inlet surface 64 and an outlet surface 66. The untreated air 32 is received on the inlet surface 64 and, as it passes through the porous bed 62, deposits organic matter therein on the inlet surface where such organic matter is attracted to and brought into contact with the titanium dioxide particles 12. As the untreated air 32 is received on the inlet surface 64 where the organic matter engages the titanium dioxide particles 12, the particles are exposed to light from the light source 56, which initiates the photocatalytic reaction of the titanium dioxide thus effectively destroying the undesirable constituents of the organic matter. The destroyed constituents of the organic matter are collected on and remain on the porous bed 62, and the air then exits the porous bed from the outlet surface 66 as treated air 60.

As is shown in FIG. 6, in another embodiment, the reactor 50 comprises a spray of titanium dioxide particles 12 into a chamber 63 into which the untreated air 32 is drawn or forced. The particles 12 are sprayed from spraying devices 20 that impart electrostatic charges to the particles, thereby causing them to be attracted to oppositely charged particles of organic matter in the untreated air 32. The electrostatic charge causes the particles 12 to stick to the organic matter. The light source 56 effects the photocatalytic reaction of the titanium dioxide to destroy the undesirable constituents of the organic matter. A reactor filter 68 is located in the reactor 50 to facilitate the collection of agglomerated particles of titanium dioxide and organic matter. Once the particles 12 agglomerate with the organic matter and are removed from the air stream, the treated air 60 is ejected from the reactor 50.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A system for photocatalytically treating a surface to affect indoor air quality, said system comprising:
electrostatically charged particles of anatase titanium dioxide, said particles having positive charges; and
a grounded substrate on which said particles are received;
wherein said particles are self-leveling with respect to said substrate as a result of electrical attraction between said particles and said substrate.

2. The system of claim 1, further comprising a light source capable of supplying UV radiation.

3. The system of claim 1, further comprising means for spraying said particles onto said substrate.

4. The system of claim 1, further comprising two oppositely charged electrodes that supply an electrical field for the electrostatic charging of said particles in response to movement of said particles through said electrical field.

5. The system of claim 1, wherein said particles are dispersed in an aqueous medium.

6. The system of claim 5, wherein said particles comprise about 2 wt. % of said aqueous medium.

7. An HVAC system for the photocatalytic treatment of airborne organic matter, said system comprising:
an arrangement of ductwork in which a flow of untreated air is received, said untreated air comprising organic matter;
a reactor in communication with said ductwork, said reactor comprising particles of anatase titanium dioxide, said particles being electrostatically charged and photocatalytically activatable; and
a collection device in said reactor;
wherein communication of said particles with said organic matter oxidizes said organic matter, wherein said collection device collects the oxidized organic matter to produce treated air, and wherein said treated air is ejected from said reactor.

8. The HVAC system of claim 7, further comprising an apparatus capable of providing for the convective flow of air through said ductwork.

9. The HVAC system of claim 7, wherein said reactor comprises a porous bed on which said particles are deposited.

10. The HVAC system of claim 7, wherein said reactor comprises a chamber in which said particles are sprayed.

11. The HVAC system of claim 7, further comprising a light source to provide for the photocatalytic activation of said particles.

12. The HVAC system of claim 8, further comprising an air flow speed detector located in said ductwork.

13. The HVAC system of claim 12, wherein said apparatus for providing for the convective flow of air through said ductwork and said air flow speed detector are in communication with a microprocessor such that upon operation of said HVAC system, closed loop control is provided to said HVAC system.

14. A method of treating a surface containing organic matter, said method comprising the steps of:
providing electrostatically charged particles of anatase titanium dioxide; and
depositing said particles as a coating on said surface containing said organic matter;
wherein in said step of depositing said particles on said surface, said particles are attracted to said surface and opposed to each other, thereby providing a self-leveling aspect to said coating.

15. The method of claim 14, wherein said step of providing electrostatically charged particles comprises spraying said particles through an electric field generated between two electrodes.

16. The method of claim 14, further comprising photocatalytically activating said electrostatically charged particles via a light source.

17. A method of treating a gaseous fluid containing organic matter, said method comprising the steps of:
providing electrostatically charged particles of anatase titanium dioxide;
providing an air stream containing organic matter into a chamber;
causing said electrostatically charged particles of anatase titanium dioxide to come into contact with said organic matter and oxidizing said organic matter;
separating said oxidized organic matter from said air stream; and
ejecting said air stream from said chamber.

18. The method of claim 17, further comprising the step of photocatalytically activating said electrostatically charged particles via a light source.

19. The method of claim 17, wherein said step of causing said electrostatically charged particles to come into contact with said organic matter comprises directing said air stream of fluid containing organic matter through a porous bed on which said electrostatically charged particles are deposited.

20. The method of claim 17, wherein said step of causing said electrostatically charged particles to come into contact with said organic matter comprises spraying said electrostatically charged particles into said air stream of fluid containing organic matter.
